(19) United States
(12) Patent Application Publication
(10) Pub. No.: US 2021/0384568 A1
(43) Pub. Date: Dec. 9, 2021

(54) BATTERY-CELL HEAT TRANSFER STRUCTURE AND BATTERY MODULE THEREOF

(71) Applicant: AMITA TECHNOLOGIES INC., Taoyuan City (TW)

(72) Inventors: Jing-Yih CHERNG, Taoyuan City (TW); Hou-Chi CHEN, Taoyuan City (TW)

(21) Appl. No.: 16/892,046

(22) Filed: Jun. 3, 2020

(51) Int. Cl. H01M 10/6554; H01M 10/6556; H01M 10/48; H01M 10/647; H01M 2/10; H01M 10/6551

(52) U.S. Cl. CPC H01M 10/6554; H01M 10/6556; H01M 10/6551; H01M 10/647; H01M 2/1077; H01M 10/482

(57) ABSTRACT

A battery-cell heat transfer structure and a battery module. includes a battery cell in a flat shape and a heat transfer layer attached on the battery cell. The heat transfer layer includes two plate portions arranged spaced apart and facing each other and multiple elastic portions arranged between the two plate portions. Each of the elastic portions is extended along a same direction between the two plate portions, so that an air flow channel is formed from top to bottom between each two adjacent elastic portions. The heat transfer layer provides an elastic restoring force and can be a corrugated board.

### TECHNICAL FIELD

The present invention relates to a battery and in particular to a battery-cell heat transfer structure and a battery module.

### BACKGROUND

As the development of the electronics industry, the use of batteries to provide power has become one of the indispensable main technologies, so batteries play an extremely important role in tech industry today. Inevitably, during a process of charging or discharging a high-efficiency rechargeable battery, internal battery materials (such as lithium electrons) generate a large amount of heat by ion exchange, causing the internal operating temperature to increase, and thus leading to thermal resistance to reduce charging or discharging efficiency. Therefore, heat dissipation of the battery is undoubtedly an important key to keep operating temperatures stable.

In a conventional battery, a structure such as an aluminum sheet or an aluminum plate can be sandwiched between battery cells of the battery to help dissipate heat. However, with this structure, when the battery cell is expanded and deformed by overheating, the aluminum sheet or the aluminum plate does not have sufficient elastic restoring force, so the aluminum sheet or plate sandwiched between the battery cells is also expanded and deformed after the battery cells' expansion and deformation. As a result, after the battery cell is restored to its shape, the aluminum sheet or aluminum plate without sufficient elastic restoring force cannot maintain a complete contact area with the two battery cells, thus reducing the expected heat dissipation performance.

In view of the above, in order to improve and solve the above-mentioned shortcomings, the inventor made a lot of research with scientific principles, and finally came up with the present invention with a reasonable design to effectively improve the above-mentioned shortcomings.

### SUMMARY

It is a main objective of the present invention to provide a battery-cell heat transfer structure and a battery module thereof. The above problem is solved by using a heat transfer layer with elastic recovery. The heat transfer layer can be a corrugated board.

It is another objective to provide a battery-cell heat transfer structure and a battery module, wherein an elastic material is injected into the heat transfer layer to increase its elastic restoring force.

Accordingly, the present invention provides a battery-cell heat transfer structure. The battery-cell heat transfer structure includes a battery cell in a flat shape and a heat transfer layer attached to the battery cell, wherein the heat transfer layer includes two plate portions disposed spaced apart and facing each other and a plurality of elastic portions arranged between the two plate portions, wherein each of the elastic portions is extended along a same direction between the two plate portions, so that an air flow channel is formed from top to bottom between each two adjacent elastic portions.

Accordingly, the present invention provides a battery module. The battery module comprises two battery cells and at least one heat transfer layer attached between the two battery cells stacked on each other, wherein the heat transfer layer includes two plate portions spaced apart and facing each other and a plurality of elastic portions arranged between the two plate portions, wherein each of the elastic portions is extended along a same direction between the two plate portions, so that an air flow channel is formed from top to bottom between each two adjacent elastic portions.

### BRIEF DESCRIPTION OF THE DRAWINGS

The disclosure will become more fully understood from the detailed description and the drawings given herein below are for illustration only, and thus do not limit the disclosure, wherein:

FIG. 1 is a perspective exploded view of the present invention.

FIG. 2 is a schematic perspective view illustrating a heat transfer layer of the present invention.

FIG. 2A is an enlarged view of a portion A of FIG. 2.

FIG. 3 is a schematic cross-sectional view of a battery cell of the present invention before expansion of the battery cell.

FIG. 3A is an enlarged view of a portion A of FIG. 3.

FIG. 4 is a schematic cross-sectional view of the expanded battery cell according to the present invention.

FIG. 4A is an enlarged view of a portion A of FIG. 4.

FIG. 5 is a schematic perspective view illustrating a battery module of the present invention.

### DETAILED DESCRIPTION

For a better understanding of the features and technical solutions of the present invention, please refer to the following detailed description of the present invention with reference to the accompanying drawings. The drawings are provided for illustration only, and are not intended to limit the present invention.

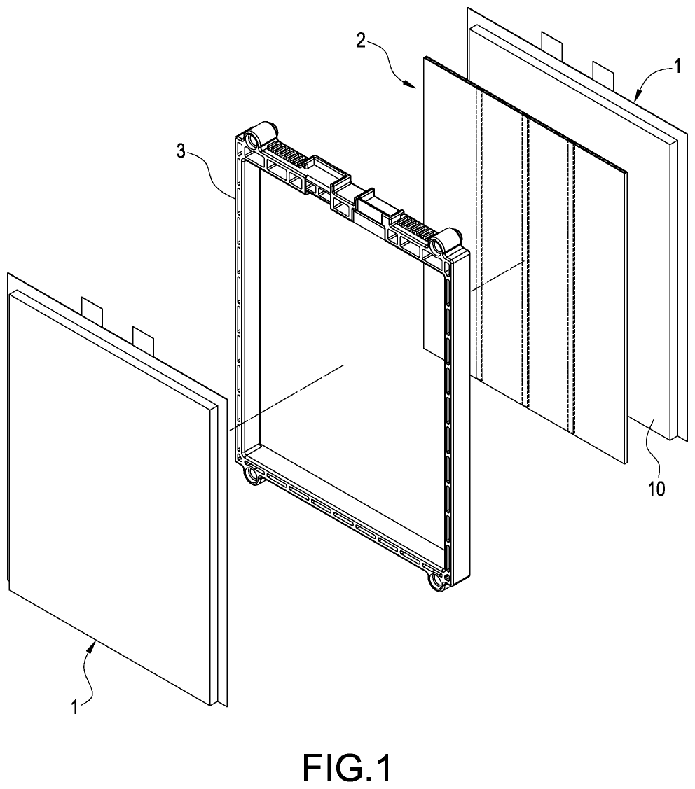

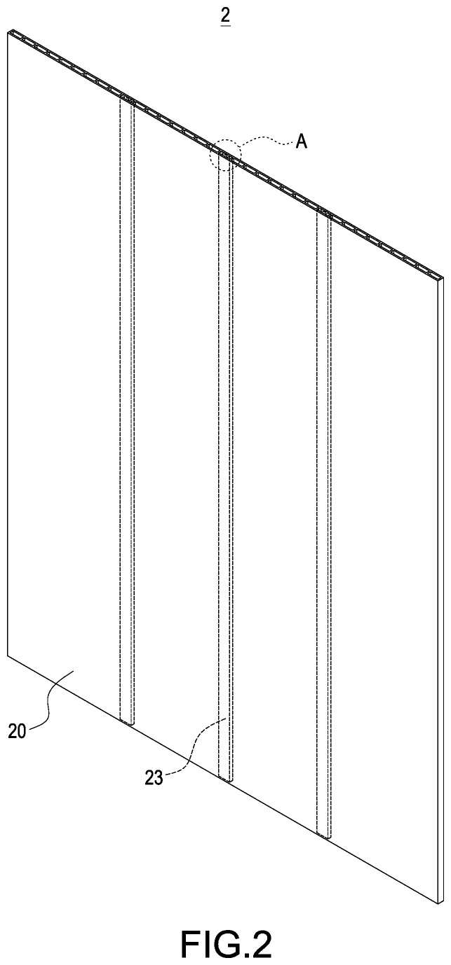

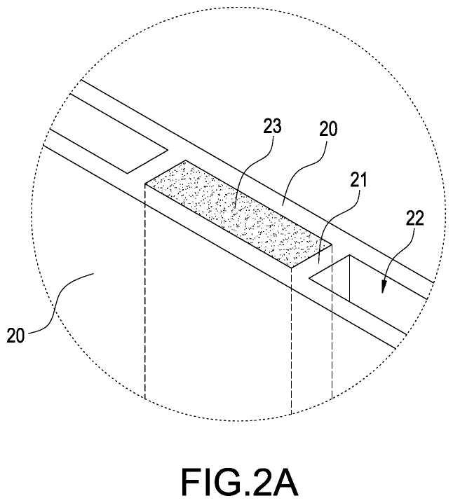

Please refer to FIG. 1 and FIG. 2, which are respectively a perspective exploded view of the present invention and a perspective view of a heat transfer layer of the present invention. The present invention provides a battery-cell heat transfer structure and a battery module. The battery-cell heat transfer structure mainly includes a battery cell 1 and a heat transfer layer 2 attached on the battery cell 1. The battery module includes multiple battery cells 1 stacked on each other. One heat transfer layer 2 mentioned above is sandwiched between any two adjacent battery cells 1. The battery module can be further provided with a frame body disposed outside any two battery cells 1 and surrounds them.

The battery cell 1 has a flat shape and includes at least one side surface 10. Each battery cell 1 has two side surfaces 10 opposite to each other, and the battery cells 1 can be stacked and used in a stacked manner.

The heat transfer layer 2 is attached to the side surface 10 of the battery cell 1. As shown in FIG. 2A, the heat transfer layer 2 includes two plate portions 20 disposed spaced apart and facing each other and a plurality of elastic portions 21 arranged between the two plate portions 20, wherein each of the elastic portions 21 is extended along a same direction between the two plate portions 20, so that an air flow channel 22 from top to bottom is formed between each two adjacent elastic portions 21. In the embodiment of the present invention, the heat transfer layer 2 can be a corrugated structure, for example, a corrugated board, to have the above structural features. Moreover, in order to increase an elastic restoring force between the two plate portions 20, an elastic material 23 can also be injected into a portion of the air flow channels 22, and the elastic material 23 can be rubber or silicone to provide better elastic recovery itself. Others of the air flow channels 22, which are not injected with the elastic material 23, remain unobstructed from top to bottom and can allow air to flow through. Therefore, heat generated by the battery cell 1 during use can be dissipated through conduction of heat through the two plate portions 20 and through the outside air entering each airflow channel 22 and taking away heat.

The battery-cell heat transfer structure and the battery module of the present invention are constructed in a manner mentioned above.

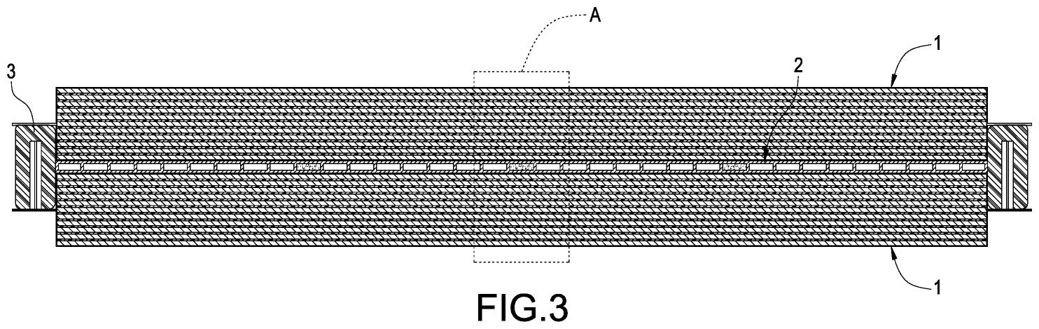

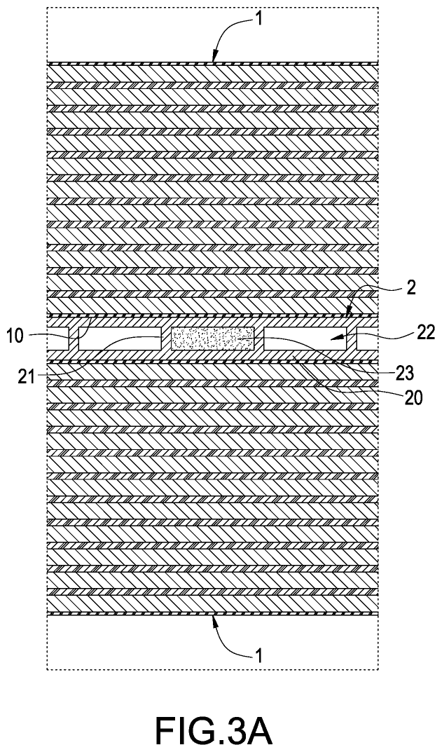

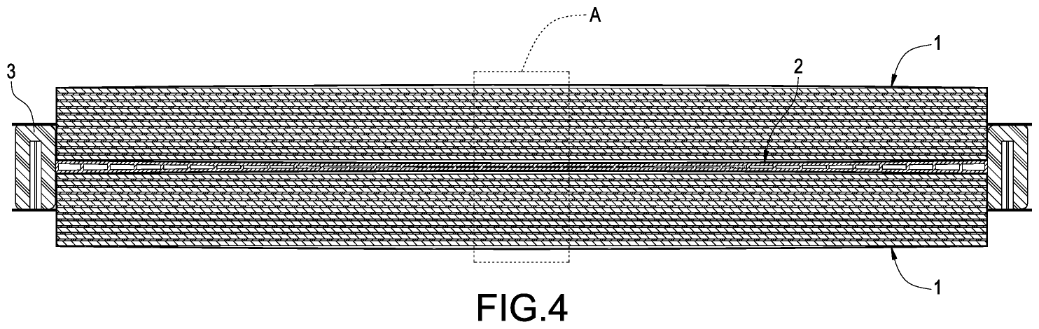

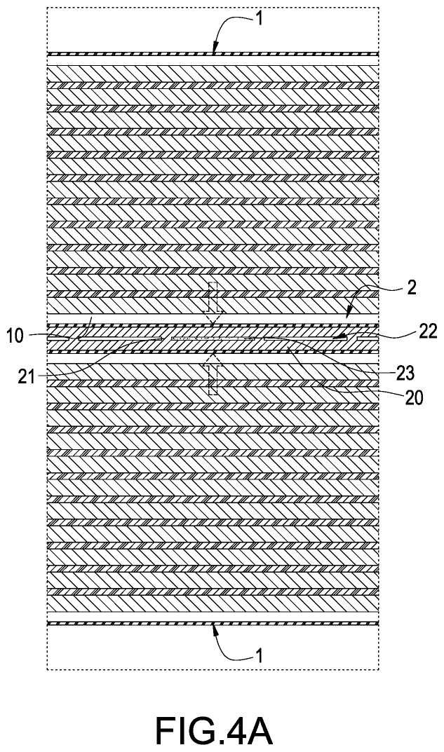

Accordingly, as shown in FIG. 3 and FIG. 3A, when each battery cell 1 is in use, the heat transfer layer 2 between any two battery cells 1 can be attached to the side surfaces 10 of the two battery cells 10 through the two plate portions 20 of the heat transfer layer 2 respectively. The heat generated by each of the battery cells 1 can be transmitted through the conduction of the two plate portions 20 and into the air flow channels 22 in the heat transfer layer 2 to be taken away by the outside air, so as to achieve heat dissipation. As shown in FIG. 4 and FIG. 4A, when each battery cell 1 undergoes expansion and deformation due to overheating during use, the elastic portion 21 provided between the two plate portions 20 of the heat transfer layer 2 can be deformed by compression. At the same time, through the elastic material 23 in each air flow channel 22, an elastic restoring force is provided after the battery cell 1 is restored to keep the two plate portions 20 attached on the side surfaces 10 of the two battery cells 1, so that the two plate portions 20 continue dissipating, through thermal conduction, the heat generated by the battery cells 1, and the thermal conduction of the heat transfer layer 2 and a heat dissipation structure thereof are not affected or damaged due to the expansion and deformation of the battery cells 1.

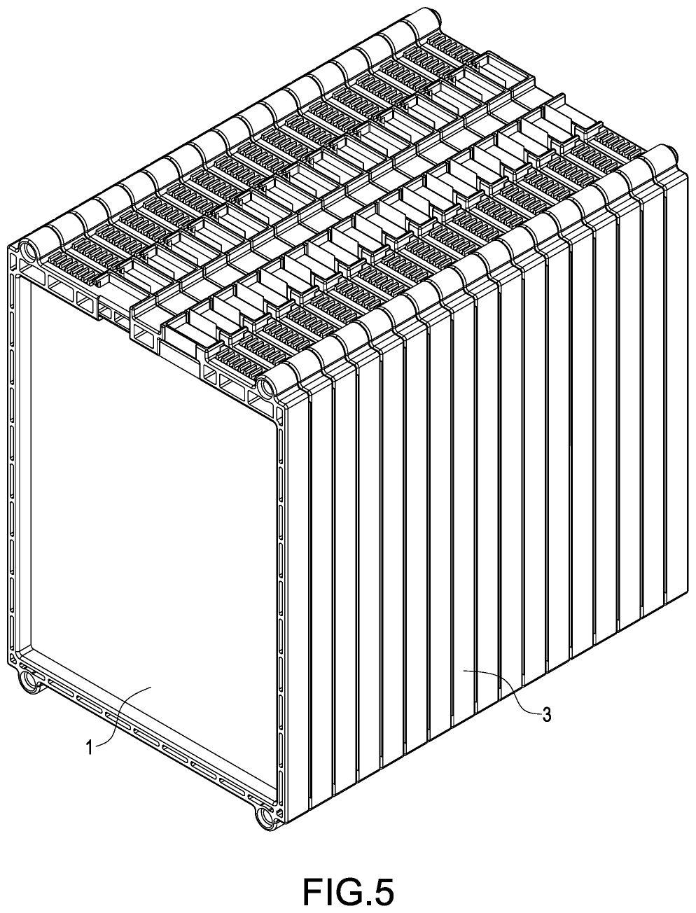

In addition, as shown in FIG. 5, the heat transfer layer 2 is disposed between the plurality of battery cells 1 and any two of the battery cells 1, and the battery cells 1 can be stacked through a plurality of frames 3 to constitute the present invention. The battery module of the present invention can be used in occasions where the battery cells 1 are connected in series or in parallel, and heat transfer and heat dissipation can be achieved through the heat transfer layer 2. At the same time, the heat transfer layer 2 can be restored from deformation when each battery cell 1 undergoes expansion and deformation, thus avoiding damages to the heat transfer and heat dissipation structure of the heat transfer layer 2.

In summary, the present invention can indeed achieve the anticipated effects and purposes, and solve the problems of conventional techniques. The present invention has novelty and inventiveness, and completely meets the requirements for patentability. Therefore, a request to patent the present invention is filed according to patent laws. Examination is kindly requested, and allowance of the present invention is solicited to protect the rights of the inventor.

It is to be understood that above descriptions are merely provided for illustrating the preferable embodiments of the present invention and are not intended to limit the protection scope of the present invention. Equivalent changes and modifications made in the spirit of the present invention are regarded as falling within the scope of the present invention.

What is claimed is:

1. A battery-cell heat transfer structure, comprising:
a battery cell in a flat shape and including at least one side surface; and
a heat transfer layer attached on the side surface of the battery cell, wherein the heat transfer layer includes two plate portions disposed spaced apart and facing each other and a plurality of elastic portions arranged between the two plate portions, wherein each of the elastic portions is extended along a same direction between the two plate portions, so that an air flow channel is formed from top to bottom between each two adjacent elastic portions.

2. The battery-cell heat transfer structure according to claim 1, wherein the heat transfer layer is a corrugated structure.

3. The battery-cell heat transfer structure according to claim 1, wherein an elastic material is injected into a portion of the air flow channels of the heat transfer layer.

4. The battery-cell heat transfer structure according to claim 3, wherein the elastic material is rubber or silicone.

5. A battery module, comprising:
two battery cells, each of the battery cells including two side surfaces opposite to each other, wherein the two battery cells are stacked on each other; and
at least one heat transfer layer attached between the side surfaces of the two battery cells, wherein the heat transfer layer includes two plate portions spaced apart and facing each other and a plurality of elastic portions arranged between the two plate portions, wherein each of the elastic portions is extended along a same direction between the two plate portions, so that an air flow channel is formed from top to bottom between each two adjacent elastic portions.

6. The battery module according to claim 5, wherein the heat transfer layer is a corrugated structure.

7. The battery module according to claim 5, wherein an elastic material is injected into a portion of the air flow channels of the heat transfer layer.

8. The battery module according to claim 7, wherein the elastic material is rubber or silicone.

9. The battery module according to claim 5, further comprising a frame body, wherein the frame body is disposed outside the two battery cells and surrounds them.
